(19) United States
(12) Patent Application Publication
(10) Pub. No.: US 2026/0098202 A1
(43) Pub. Date: Apr. 9, 2026

(54) ADDITIVES FOR ENHANCING WEAR CONTROL PERFORMANCE OF OILFIELD CORROSION INHIBITORS

(71) Applicant: Baker Hughes Oilfield Operations LLC, Houston, TX (US)

(72) Inventor: Carlos M. Menendez, Houston, TX (US)

(73) Assignee: Baker Hughes Oilfield Operations LLC, Houston, TX (US)

(21) Appl. No.: 18/909,386

(22) Filed: Oct. 8, 2024

(51) Int. Cl. C09K 8/54; E21B 37/06

(52) U.S. Cl. CPC C09K 8/54; E21B 37/06; C09K 2208/32; C09K 2208/34

(57) ABSTRACT

A wear-reduction corrosion inhibitor includes a base corrosion inhibitor, having a fatty acid, and a lubricity additive, having an ester-based lubricant. In one aspect, a method is disclosed for treating downhole equipment within a well with a wear-reduction corrosion inhibitor. The method includes the steps of preparing a wear-reduction corrosion inhibitor by combining the base corrosion inhibitor and the lubricity additive, then pumping the wear-reduction corrosion inhibitor into an annulus of the well and flushing the annulus with water.

### FIELD OF THE INVENTION

The subject matter disclosed herein generally relates to compositions and processes for treating equipment with a wear-reduction corrosion inhibitor.

### BACKGROUND OF THE INVENTION

Artificial lift technologies are often used to improve production levels in declining oil and gas wells. As more wells are being drilled at horizontal orientations, downhole pump components are required to navigate greater deviations in the well. The average depth for wells has also increased during the last decade. Deeper wells that are more difficult to navigate contribute to increased wear for the downhole components of artificial lift systems. Rod lift systems, for example, experience failure with greater frequency and within shorter timeframes as the result of frictional wear between the rod string and the casing or borehole. When these artificial lift systems fail, repair is costly and involves time-intensive labor and lost production.

Certain mechanical solutions have been proposed to reduce the frequency and severity of lift system failures by mitigating wear degradation. Guide structures, for example, may be positioned within the well to reduce direct contact between the rod string in a rod lift system and the well casing. Although mechanical intervention has helped to alleviate downhole friction, these solutions have had limited overall success in preventing lift system failure. It is therefore desirable to implement chemistries and processes to reduce frictional wear on artificial lift systems to increase the lifespan of these systems, particularly when deployed in wells with corrosive fluids.

### SUMMARY OF THE INVENTION

The inventive concepts disclosed are generally directed to compositions and processes for treating equipment with a wear-reduction corrosion inhibitor.

In one aspect, a wear-reduction corrosion inhibitor is disclosed and includes a base corrosion inhibitor and a lubricity additive. The base corrosion inhibitor includes a fatty acid, and the lubricity additive includes an ester-based lubricant.

In another aspect, a method is disclosed for treating downhole equipment within a well with a wear-reduction corrosion inhibitor. The method includes the steps of preparing the wear-reduction corrosion inhibitor by combining a base corrosion inhibitor having a fatty acid and a lubricity additive having an ester-based lubricant and pumping the wear-reduction corrosion inhibitor into an annulus of the well.

In yet another aspect, a method is disclosed for treating downhole equipment within a well with a wear-reduction corrosion inhibitor, which is prepared by combining a base corrosion inhibitor that includes a fatty acid with a lubricity additive that includes an ester-based lubricant. The wear-reduction corrosion inhibitor is then combined with a carrier fluid and pumped with the carrier fluid into the well. The well is subsequently flushed with water or a water-based fluid.

### BRIEF DESCRIPTION OF DRAWINGS

The above and other objects and advantages of this invention may be more clearly seen when viewed in conjunction with the accompanying drawing wherein:

FIG. 1 graphically illustrates the effect of lubricity additive viscosity on friction coefficient reduction for various wear-reduction corrosion inhibitors in accordance with exemplary embodiments compared with a base corrosion inhibitor.

FIG. 2 graphically illustrates friction reduction for the base corrosion inhibitor of FIG. 1 based concentration of an exemplary ester-based lubricant.

FIG. 3 graphically illustrates the friction coefficient traces for wear-reduction corrosion inhibitors with 14 wt. % lubricity additive compared to a base corrosion inhibitor prepared neat and with 1.7× concentration of actives.

FIG. 4 depicts ball wear results for wear-reduction corrosion inhibitors with the base corrosion inhibitor of FIG. 1 and around 14 wt. % lubricity additive.

FIG. 5 graphically illustrates the effect of lubricity additive concentration on friction reduction for various wear-reduction corrosion inhibitors in accordance with exemplary embodiments compared with another base corrosion inhibitor.

FIG. 6 depicts ball wear results for wear-reduction corrosion inhibitors with the base corrosion inhibitor of FIG. 5 and around 22.5 wt. % lubricity additive.

FIG. 7 graphically illustrates the effect of lubricity additive concentration on friction reduction for various wear-reduction corrosion inhibitors in accordance with exemplary embodiments compared with yet another base corrosion inhibitor.

FIG. 8 depicts average friction coefficients for various wear-reduction corrosion inhibitors in accordance with exemplary embodiments.

FIG. 9 depicts final friction coefficients for various wear-reduction corrosion inhibitors in accordance with exemplary embodiments.

FIG. 10 depicts a correlation between ball wear and viscosity for neat base corrosion inhibitors and wear-reduction controlling inhibitors formulated in accordance with exemplary embodiment.

FIG. 11 depicts plate wear volumes for neat base corrosion inhibitors and wear-reduction controlling inhibitors formulated in accordance with exemplary embodiments.

FIG. 12 depicts corrosion rates obtained using wheel bomb testing for neat base corrosion inhibitors and wear-reduction corrosion inhibitors formulated in accordance with exemplary embodiments.

### DETAILED DESCRIPTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

It has been discovered that the introduction of certain compounds with ester-functionality to oilfield corrosion inhibitors leads to a significant reduction in friction and wear. Accordingly, compositions and processes are disclosed herein for enhancing the wear control performance of oilfield corrosion inhibitors for rod lift and other artificial lift systems. In one aspect, a wear-reduction corrosion inhibitor includes a base corrosion inhibitor and a lubricity additive, which includes one or more ester-based lubricants. It will be appreciated that the lubricity additive may include 2, 3, 4, 5, 6, 7, etc. ester-based lubricants in combination. The base corrosion inhibitor is generally present in the wear-reduction corrosion inhibitor in an amount between about 70 weight percent (wt. %) and about 90 wt. %, whereas the lubricity additive is present in an amount between about 10 wt. % and about 30 wt. %. Unless otherwise specified, the weight percentages listed herein are based on the total weight of the wear-reduction corrosion inhibitor.

The base corrosion inhibitor may include one or more fatty acids such as, without limitation, tall oil fatty acids and derivatives of the same, dimer fatty acids and derivatives of the same, and mixtures thereof. The base corrosion inhibitor may also include one or more of each of the following components: imidazolines, phosphate esters, and quaternary amines. Suitable imidazolines include, without limitation, imidazoline/polyamines and reaction products of diethylenetriamine and tall oil fatty acids, and suitable phosphate esters include polyoxyethylene tridecyl ether phosphate and thiophosphate ester ethoxylated. One non-limiting example for a suitable quaternary amine is alkyl (coco) dimethylbenzil ammonium chloride (ADBAC). In one embodiment, the base corrosion inhibitor includes between about 1 wt. % and about 20 wt. % fatty acid, between about 1 wt. % and about 20 wt. % imidazoline, and between about 2 wt. % and about 20 wt. % phosphate ester. In another embodiment, the base corrosion inhibitor includes between about 5 wt. % and about 20 wt. % quaternary amine.

The base corrosion inhibitor may also include one or more surfactants, demulsifiers, and solvents (e.g., aromatic solvents, oil distillates, alcohols, etc. and combinations of the same). When included in the base corrosion inhibitor, the surfactant(s) may be present in a range between about 1 wt. % and about 5 wt. %, the demulsifier(s) may be present in a range between about 1 wt. % and about 2 wt. %, and the solvent(s) may be present in a range between about 30 wt. % and about 70 wt. %.

In one non-limiting embodiment, the base corrosion inhibitor is formulated with between about 1 wt. % and about 10 wt. % fatty acid, between about 2 wt. % and about 10 wt. % surfactant, between about 5 wt. % and about 20 wt. % imidazoline, between about 2 wt. % and about 15 wt. % phosphate ester, and between about 1 wt. % and about 2 wt. % demulsifier. In such embodiments, the wear-reduction corrosion inhibitor includes between about 5 wt. % and about 30 wt. % lubricity additive and may also include between about 50 wt. % and about 70 wt. % solvent.

In another non-limiting embodiment, the base corrosion inhibitor includes between about 2 wt. % and about 20 wt. % fatty acid, between about 1 wt. % and about 5 wt. % surfactant, between about 1 wt. % and about 10 wt. % imidazoline, between about 5 wt. % and about 20 wt. % phosphate ester, and between about 5 wt. % and about 20 wt. % quaternary amine. Such embodiments include between about 5 wt. % and about 30 wt. % lubricity additive for the wear-reduction corrosion inhibitor. The wear-reduction corrosion inhibitor may also include between about 30 wt. % and about 60 wt. % solvent.

Turning to the lubricity additive of the wear-reduction corrosion inhibitor, the ester-based lubricant(s) are natural or synthetic ester oils, such as monoesters, diesters, polyol esters, and complex esters. Each ester-based lubricant may be saturated or unsaturated. Suitable diesters include oleochemical diesters and petrochemical diesters; suitable polyol esters include trimethylolpropane oleate; and the complex esters may be dimerate esters, trimerate esters, trimellitate esters, or polyesters of the same. Without limitation, suitable complex esters include trimethylolpropane oleate dimerate, diisopropyl ether C9 dimerate, ethylene glycol dimerate, and polyesters of ethylene glycol dimerate.

The wear-reduction corrosion inhibitor may be prepared by combining or mixing the base corrosion inhibitor and lubricity additive before the wear-reduction corrosion inhibitor is introduced into an oil and gas well to treat downhole equipment therein. The wear-reduction corrosion inhibitor is optionally mixed with a carrier fluid prior to introduction into the well. Suitable carrier fluids include oil-based fluids such as diesel, kerosene, jet fuel, crude oil, and condensate. The amount of wear-reduction corrosion inhibitor used for a treatment ranges in concentration from about 10 to about 100 ppm wear-reduction corrosion inhibitor to carrier fluid. The concentration, total volume and frequency of treatments using the wear-resistant corrosion inhibitor will depend on a number of factors, including the quality and quantity of hydrocarbon production from the well.

In one aspect, the downhole equipment within an oil and gas well is treated by preparing the wear-reduction corrosion inhibitor, pumping a slug of the wear-reduction corrosion inhibitor into an annulus of the well, and then flushing the annulus with a volume of water or a water-based fluid (a “water-based flush”). After the wear-reduction corrosion inhibitor is introduced into the annulus, it may be allowed to coat the exposed surfaces of the annulus, the downhole equipment, or both for a predetermined residence time prior to introduction of the water-based flush. Any wear-reduction corrosion inhibitor that does not form a protective film on the downhole equipment after this predetermined residence time may be pushed further through the annulus using the water-based flush. The water-based flush and the wear-reduction corrosion inhibitor do not significantly mix, thereby allowing the water-based flush to push the water-reduction corrosion inhibitor to coat additional portions of the annulus and/or downhole equipment. The excess wear-reduction corrosion inhibitor that is not coated onto the annulus or downhole equipment after introduction of the water-based flush may be returned to the surface.

In one embodiment, the wear-reduction corrosion inhibitor and the water-based flush are drawn from the annulus and pumped to the surface through the production tubing to allow the wear-reduction corrosion inhibitor to provide a protective film on the interior surfaces of the artificial lift systems, production tubing and any other downhole and surface components connected within the pumping and completion systems. The wear-reduction corrosion inhibitor may be stored in a surface tank. The steps of pumping the wear-reduction corrosion inhibitor into the annulus and flushing with water or a water-based fluid may be performed at periodic intervals (e.g., daily, weekly, every two weeks, every three weeks, monthly, etc.) or on an as-needed basis to maintain the protective film on the downhole equipment from the wear-reduction corrosion inhibitor. Applying circulation after the pumping and flushing steps is optional, and, in certain embodiments, no circulation is applied after the pumping and flushing steps are performed.

In one embodiment, the wear-reduction corrosion inhibitor is introduced into the oil and gas well to treat downhole components of an artificial lift system (e.g., a rod lift production system). It will be appreciated that the wear-reduction corrosion inhibitor may also be used to treat other metal equipment or parts exposed to friction or other stresses in corrosive environments, both downhole and at the surface, including but not limited to wellbore tubulars, pipelines, wellheads, production tubing, process equipment, process tanks and conduits, and storage tanks.

To treat production tubing, in general, between about 0.5 gallons and about 2 gallons of the wear-reduction corrosion inhibitor are pumped into the annulus per 2,000 ft. of production tubing. As used herein, the term “gallon” refers to a U.S. gallon, as opposed to an imperial gallon. The amount of water-based flush used for flushing may depend on the fluid level within the annulus. If the fluid level is determined to be less than 1,000 ft., about 2 barrels of water-based flush may be introduced into the annulus. Where the fluid level within the annulus is higher than 1,000 ft., about 10 barrels of water-based flush may be introduced in the flushing step. The term “barrel,” as used herein, refers to 42 gallons.

### EXAMPLES

The composition and process for treating equipment with a wear-reduction corrosion inhibitor is further illustrated by the following Examples, which are provided for the purpose of demonstration rather than limitation.

### Example 1

In this Example 1, several drops of each ester-based lubricant were applied to the surface of a base corrosion inhibitor to observe the resulting effect when performing wear measurements. The friction coefficient and wear measurements were conducted using a Tribometer TRB3 from Anton Paar®. The measurements were carried out with linear reciprocating movement using the ball-on-flat configuration according to the parameters shown in Table 1. Both the 100Cr6 balls and the L80 plates were cleaned in an ultrasonic bath for 3 minutes in xylene and acetone, respectively, followed by a wash with isopropanol.

TABLE 1
Linear Reciprocating Parameters.

| | |
|---|---|
| Parameters | Values |

| Load/Pressure | 5N/~1 GPa | |
|---|---|---|
| Temperature | Room temperature | |
| Sliding velocity | 5 | mm/s |
| Frequency | 0.52 | Hz |
| Length of the experiments | 1.5 | hrs. |

| | |
|---|---|
| Ball Material/Ra Factor | 100Cr6/Ra = 0.05 μm |
| Plate material/Ra Factor | API 5CT L80-1/Ra = 0.075 μm |

As soon as the steel plate was securely locked on the linear reciprocating holder and the ball holder was balanced, a few drops of each sample was applied to the plate. The ball was subsequently put into contact with the plate, and the measurement was started. To evaluate whether the wear-reduction corrosion inhibitors maintained suitable deliverability during winter conditions, the viscosity of each sample was evaluated at −40° C. To meet internal testing restrictions, it was required that the viscosity of the samples not exceed 1,000 cP at −40° C. An automatic kinematic viscometer SVM 3001 from Anton Paar® was used to monitor viscosity.

The Tribometer TRB3 measurements resulted in a plot of the friction coefficient as a function of the sliding time. After processing the friction data, an average friction coefficient and a final friction coefficient were determined. The wear values on the 100Cr6 balls and the L80 plates were determined following ASTM standard G133-22. The scars produced by wear both on the ball and on the plate were imaged using a calibrated white light interferometer from Bruker®. The scar images were later processed using the Vision64® software from Bruker® to determine the scars' volume in μm³.

For this Example 1, Samples 100 and 102 were controls, having a base corrosion inhibitor (“Base CI #1”) without any added lubricity additive, where Base CI #1 was formulated according to Table 2. Solvent served as the balance (78.5 wt. %) for Samples 100 and 102.

TABLE 2
Base CI #1 Formulation.

| | Wt. % based on |
|---|---|
| Component | total Sample 100/102 |
| Fatty acid | 21.5 |
| Imidazoline | |
| Phosphate ester | |
| Demulsifier | |
| Surfactant #1 | |
| Surfactant #2 | |

As outlined in Table 3, samples of the wear-reduction corrosion inhibitor were prepared with Base CI #1 and the following lubricity additives: Sample 104 included 40 wt. % saturated polyol ester (having a kinematic viscosity of 46 centistoke (cSt) at 40° C.); Sample 106 included 40 wt. % oleochemical diester (94 cSt at 40° C.); Sample 108 included 40 wt. % saturated polyol ester (different from Sample 104, having a kinematic viscosity of 145 cSt at 40° C.); Sample 110 included 40 wt. % a polyester of ethylene glycol dimerate (between 800 and 1600 cSt at 40° C.); and Sample 112 included 30 wt. % saturated polyol ester of Sample 108. For each of Samples 104, 106, 108, 110, and 112, the balance was solvent.

TABLE 3
Wt. % Components for Samples 104, 106, 108, 110, and 112.

| Sample | Base CI #1 | Ester-based lubricant | Solvent |
|---|---|---|---|
| 104 | 21.5 | 40 | 38.5 |
| 106 | 21.5 | 40 | 38.5 |
| 108 | 21.5 | 40 | 38.5 |
| 110 | 21.5 | 40 | 38.5 |
| 112 | 21.5 | 30 | 48.5 |

FA = fatty acid
IM = imidazoline
PE = phosphate ester
D = demulsifier
S = surfactant

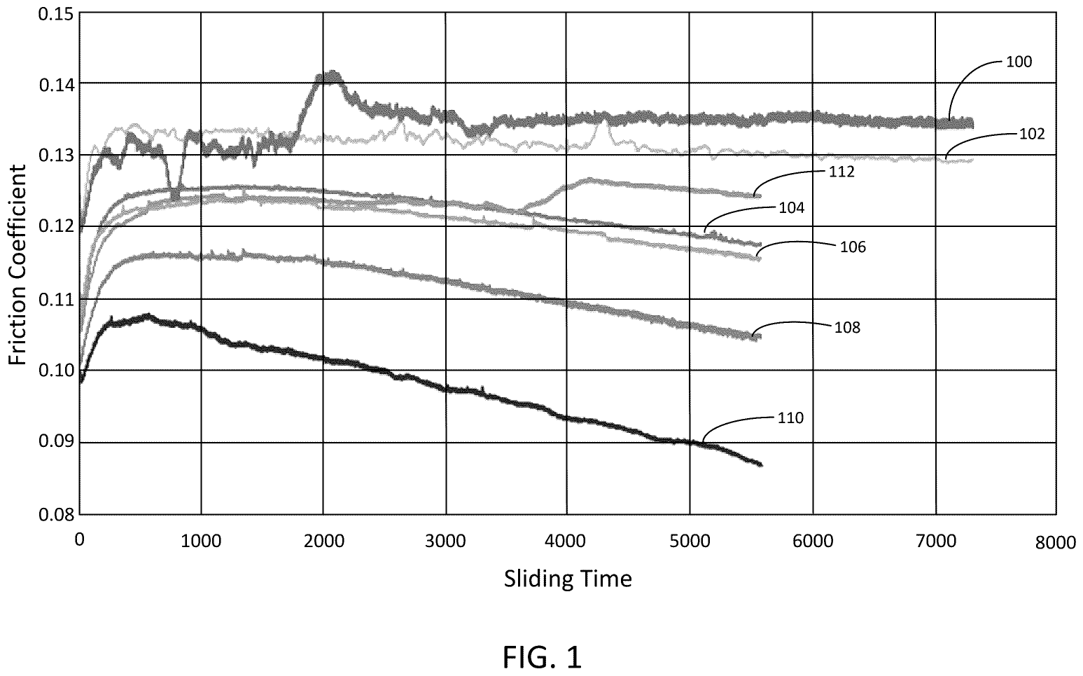

FIG. 1 shows the effect of the various ester-based lubricants on friction reduction over time. With the same concentration of lubricity additive (40 wt. %) used with 21.5 wt. % Base CI #1, Samples 104, 106, 108, and 110 demonstrated a correlation between the lubricity additive's viscosity and friction reduction. Namely, as kinematic viscosity increased, the friction coefficient decreased. The data shows the following friction reduction trend for the tested ester-based lubricants: the polyester of ethylene glycol dimerate outperformed Sample 108 saturated polyol ester, which outperformed oleochemical diester, which outperformed the Sample 104 saturated polyol ester. Based on this result, the polyester of ethylene glycol dimerate was determined to be the best lubricant to combine with Base CI #1. It should be noted that, as shown in FIG. 1, each of the wear-reduction corrosion inhibitors that included 40 wt. % lubricity additive (Samples 104, 106, 108, and 110) showed a reduction of the friction coefficients over time, indicating that the liquid drops applied onto the Tribometer TRB3 plate for testing were losing solvent and thickening over time. For this reason, a filming and drip method was employed for the remainder of the friction and wear evaluations (Examples 2 through 5).

### Example 2

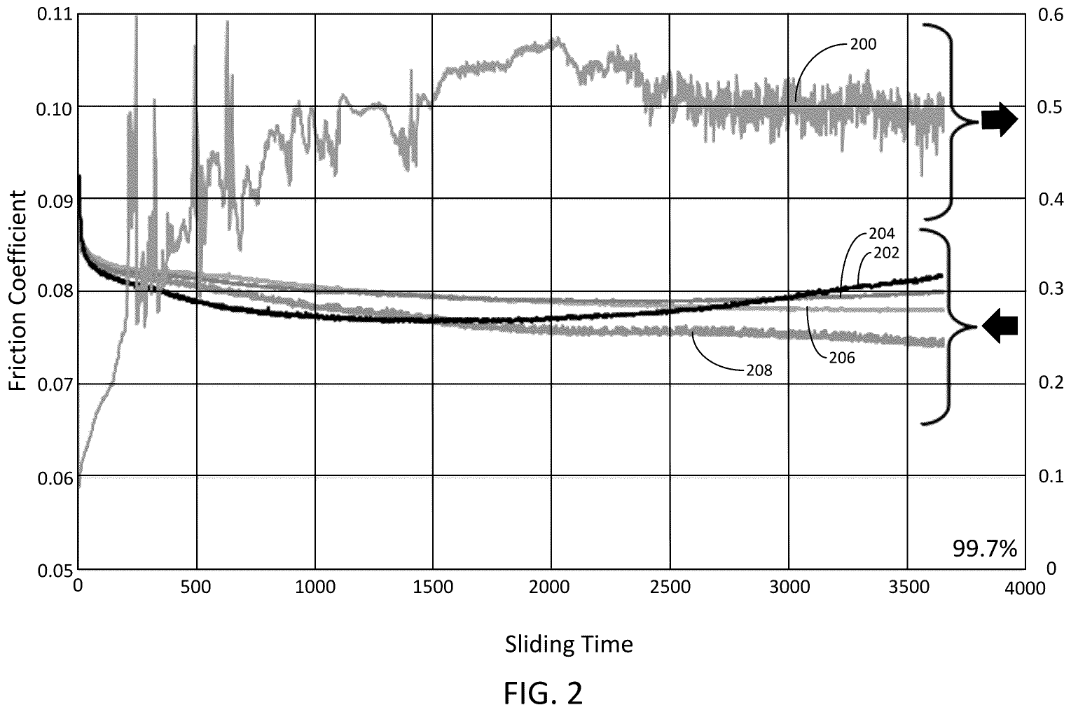

FIG. 2 shows the relationship between friction reduction and the concentration of lubricity additive in the wear-reduction corrosion inhibitor. These tests used the filming and drip method, in which the steel L80 plates were first filmed with each sample using a disposable transfer pipette, then allowed to drip for 30 minutes. Once dried, the filmed samples were mounted on the linear reciprocating holder and locked securely. At this point, the 100Cr6 balls were mounted on the ball holder, and the ball was briefly put in contact with chemical while all the residual chemical on the ball holder (not the ball) was removed. Subsequently, the ball holder was balanced and after allowing the ball to contact the plate, the measurement was started. All linear reciprocating parameters were the same as those in Table 1, except that the experiments were performed for 1 hour rather than 1.5 hours.

Sample 200 was 21.5 wt. % Base CI #1 with solvent as the balance (no lubricity additive). The wear-reduction corrosion inhibitors of Samples 202, 204, 206, and 208 included 21.5 wt. % Base CI #1 and, respectively, 14.5 wt. %, 20 wt. %, 25 wt. %, and 30 wt. % polyester of ethylene glycol dimerate as lubricity additives. The balance for Samples 202, 204, 206, and 208 was solvent.

The arrows on FIG. 2 indicate which Y-axis should be used for the data values of the bracketed samples. As such, Sample 200 should be compared against the right Y axis, while Samples 202, 204, 206, and 208 should be read using the left Y axis. Sample 200 exhibited a friction coefficient of 0.5, whereas the combination of the polyester of ethylene glycol dimerate and Base CI #1 reduced the final friction coefficients to 0.082 (Sample 202), 0.080 (Sample 204), 0.078 (Sample 206), and 0.074 (Sample 208). The observed friction coefficient reduction from 0.5 to about 0.08 represented an approximately 84% friction reduction.

On the other hand, internal testing restrictions established a maximum viscosity of 1,000 cP at −40° C. Table 4 shows viscosity values at −40° C. for Base CI #1 mixed with 10 wt. % to 20 wt. % polyester of ethylene glycol dimerate and solvent as the balance. Based on the internal restrictions on maximum viscosity, the maximum suitable concentration for the polyester of ethylene glycol dimerate was 14 wt. %, which produced a viscosity of 980.5 cP.

TABLE 4
Viscosities for Wear-Reduction Corrosion Inhibitor with 21.5
wt. % Base CI #1 and Polyester of Ethylene Glycol Dimerate.

| | Viscosity | | Viscosity |
|---|---|---|---|
| | at −40° C. | Density | at −40° C. |
| Blend | (cSt) | (g/cm³) | (cP) |
| Sample 200 | 92 | 0.9801 | 90.2 |
| Base CI #1 + polyester of ethylene glycol dimerate | 530 | 0.9791 | 518.9 |
| (10 wt. %) + solvent (balance) | | | |
| Base CI #1 + polyester of ethylene glycol dimerate | 750 | 0.9796 | 734.7 |
| (12.5 wt. %) + solvent (balance) | | | |
| Base CI #1 + polyester of ethylene glycol dimerate | 880 | 0.9803 | 862.7 |
| (13.0 wt. %) + solvent (balance) | | | |
| Base CI #1 + polyester of ethylene glycol dimerate | 1,000 | 0.9805 | 980.5 |
| (14.0 wt. %) + solvent (balance) | | | |
| Base CI #1 + polyester of ethylene glycol dimerate | 1,100 | 0.9796 | 1077.6 |
| (14.5 wt. %) + solvent (balance) | | | |
| Base CI #1 + polyester of ethylene glycol dimerate | 2100 | 0.9818 | 2061.8 |
| (20 wt. %) + solvent (balance) | | | |

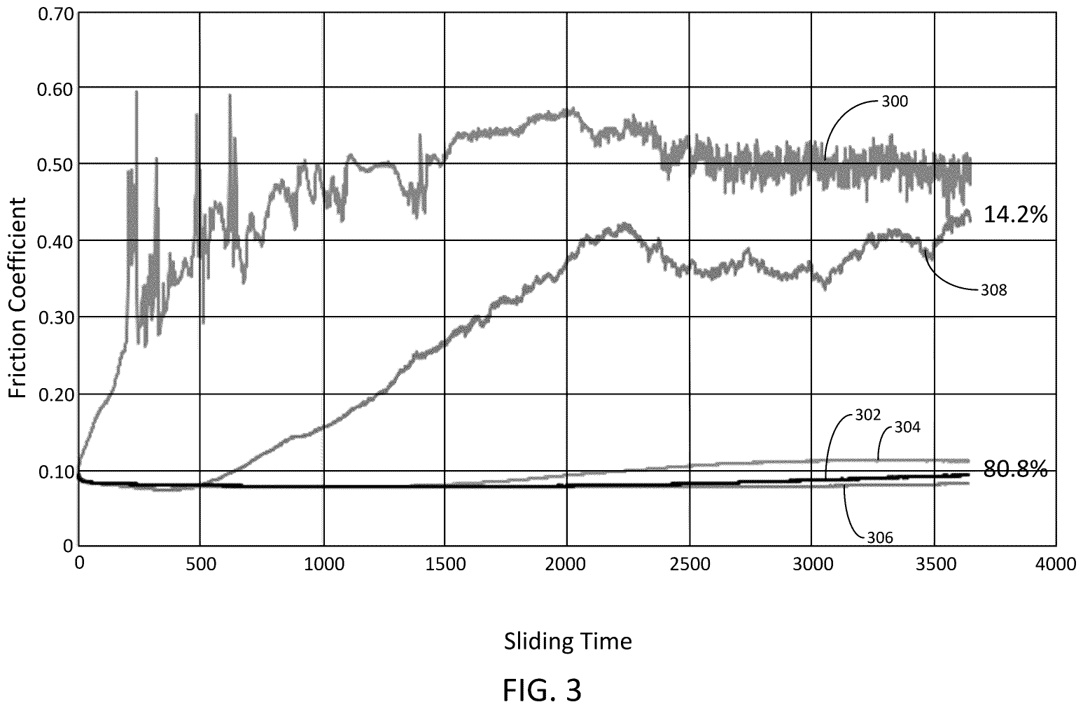

FIG. 3 depicts the friction coefficient traces for Sample 300 (21.5 wt. % Base CI #1 and solvent as the balance), for which the Tribometer TRB3 plate was filmed and left to dry for 30 minutes before running the measurement. Samples 302, 304, and 306 were three formulations of 21.5 wt. % Base CI #1 with 14 wt. % polyester of ethylene glycol dimerate and solvent as the balance. Sample 308 was a base corrosion inhibitor with the same components as Sample 300 (having Base CI #1 and solvent) but with 1.7× actives concentration. Sample 308 was formulated to match the cost of preparing Samples 302, 304, and 306 and to compare the differences in friction and wear reduction. Before running the Sample 308 measurement, the Tribometer TRB3 plate was filmed and left to dry for 30 minutes.

The addition of 14 wt. % polyester of ethylene glycol dimerate to Base CI #1 in Samples 302, 304, and 306 exhibited 80.8% friction reduction and close to a 100% reduction in ball wear. By contrast, a 1.7× increase in the concentration of actives for Base CI #1 only reduced friction by 14.2% (see Sample 308).

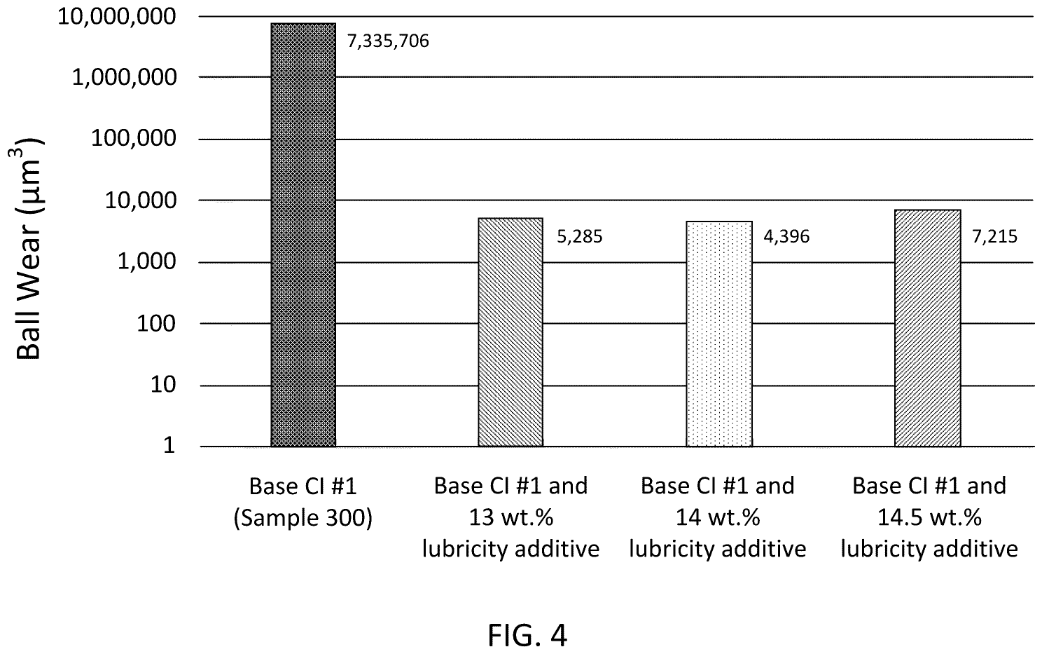

FIG. 4 and Table 5 show ball and plate wear results for Base CI #1 compared to wear-reduction corrosion inhibitors having Base CI #1 and the polyester of ethylene glycol dimerate in concentrations of 13 wt. %, 14 wt. % and 14.5 wt. %. As demonstrated in FIG. 4, varying the lubricity additive content by 0.5 wt. % to 1 wt. % did not have a significant impact on wear performance.

TABLE 5
Ball and Plate Wear for Wear-Reduction Corrosion Inhibitors with
21.5 wt. % Base CI #1 and Polyester of Ethylene Glycol Dimerate.

| Blend | Ball Wear (mm³) | Plate Wear (mm³) |
|---|---|---|
| Sample 300 | 6,708,449 | 6,092,414 |
| Sample 308 | 642,818 | N.D. |
| Base CI #1 + polyester of ethylene glycol dimerate | 5,285 ± 244 | N.D. |
| (13.0 wt. %) + solvent (balance) | | |
| Base CI #1 + polyester of ethylene glycol dimerate | 4,396 ± 136 | N.D. |
| (14.0 wt. %) + solvent (balance) | | |
| Base CI #1 + polyester of ethylene glycol dimerate | 7,215 ± 1,734 | N.D. |
| (14.5 wt. %) + solvent (balance) | | |

### Example 3

For this Example 3, Sample 500 served as the control, having the base corrosion inhibitor (“Base CI #2”) formulated according to Table 6 without any added lubricity additive. Sample 500 included solvent as the balance (66.67 wt. %).

TABLE 6
Base CI #2 Formulation.

| | Wt. % based on total |
|---|---|
| Component | base corrosion inhibitor |
| Fatty acids #1 and #2 | 33.33 |
| Imidazoline | |
| Phosphate ester | |
| Surfactant | |
| Quaternary amine | |

Table 7 shows viscosities for wear-reduction corrosion inhibitors measured at −40° C. with Base CI #2 and varying concentration of lubricity additive.

TABLE 7
Viscosities for Wear-Reduction Corrosion Inhibitors with 33.33
wt. % Base CI #2 and Polyester of Ethylene Glycol Dimerate.

| | Viscosity | | Viscosity |
|---|---|---|---|
| | at −40° C. | Density | at −40° C. |
| Blend | (cSt) | (g/cm³) | (cP) |
| Base CI #2 + solvent (balance) | 26 | 0.9478 | 24.6 |
| Base CI #2 + polyester of ethylene glycol dimerate | 710 | 0.9633 | 683.9 |
| (20 wt. %) + solvent (balance) | | | |
| Base CI #2 + polyester of ethylene glycol dimerate | 660 | 0.9648 | 636.8 |
| (21.5 wt. %) + solvent (balance) | | | |
| Base CI #2 + polyester of ethylene glycol dimerate | 790 | 0.9648 | 762.2 |
| (22.5 wt. %) + solvent (balance) | | | |
| Base CI #2 + polyester of ethylene glycol dimerate | 890 | 0.9648 | 858.7 |
| (23.5 wt. %) + solvent (balance) | | | |
| Base CI #2 + polyester of ethylene glycol dimerate | 1400 | ~0.9648 | 1,350 |
| (25 wt. %) + solvent (balance) | | | |

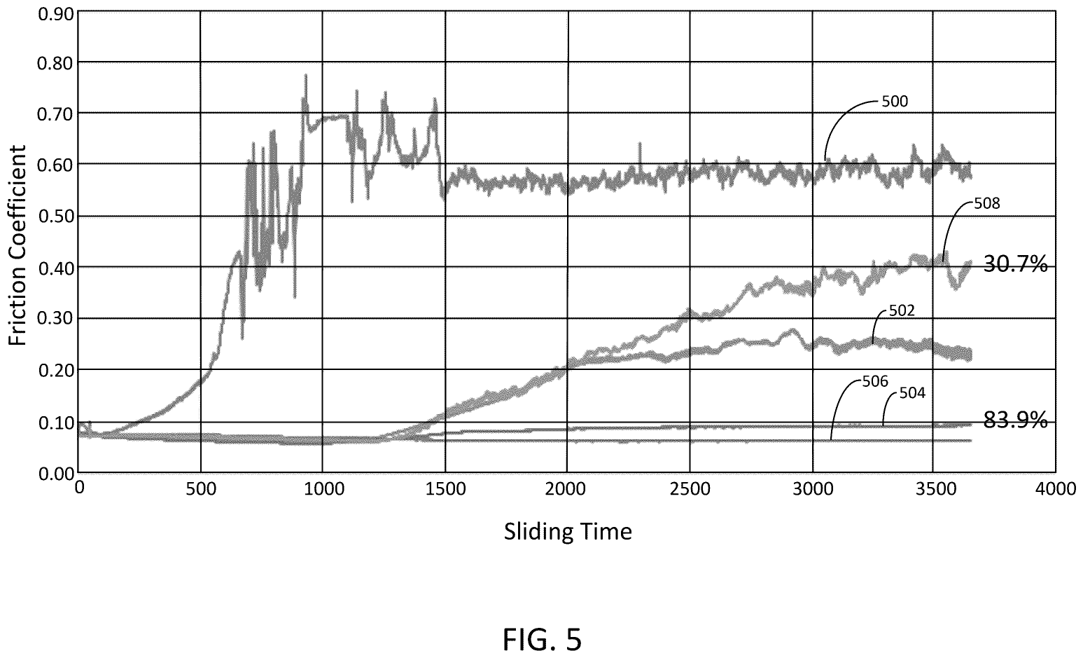

FIG. 5 depicts the friction coefficient traces for Sample 500 (33.33 wt. % Base CI #2 and solvent as the balance), for which the Tribometer TRB3 plate was filmed and left to dry for 30 minutes before running the measurement. Samples 502, 504, and 506 were three formulations of the wear-reduction corrosion inhibitor with 33.33 wt. % Base CI #2 and, respectively, 20 wt. %, 22.5 wt. %, and 25 wt. % polyester of ethylene glycol dimerate, with solvent as the balance. Sample 508 was a base corrosion inhibitor with the same components as Sample 500 but with 1.8× actives concentration. Like Sample 500, Sample 508 was filmed onto the Tribometer TRB3 plate and left to dry for 30 minutes before running the measurement. Sample 504 exhibited friction reduction of 83.9%, whereas Sample 508 produced only a 30.7% reduction in friction.

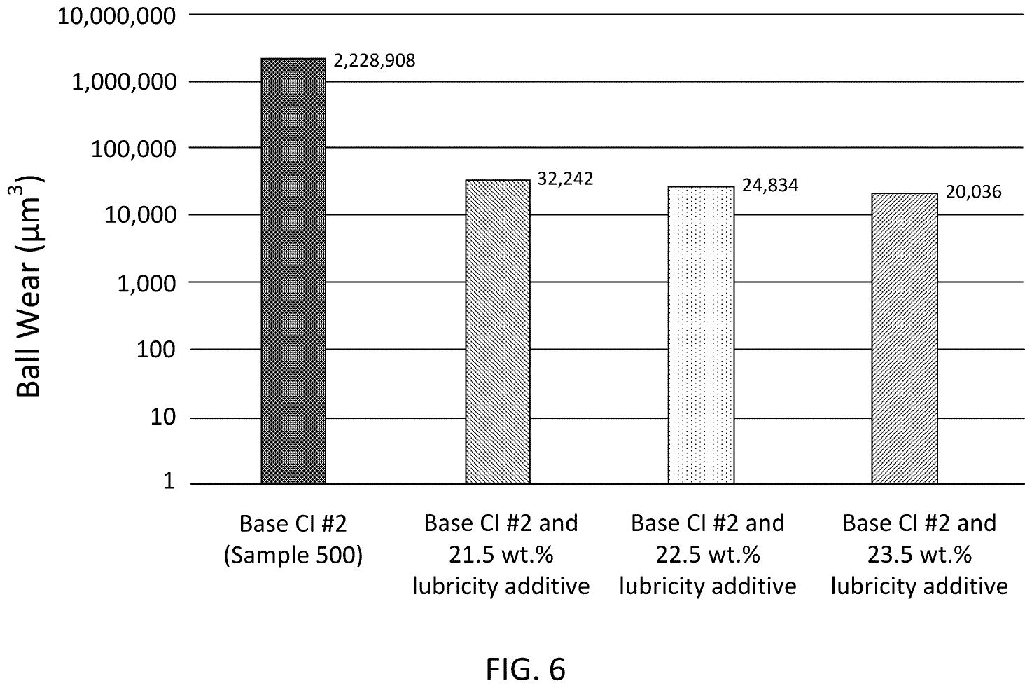

FIG. 6 and Table 8 show ball and plate wear results for Base CI #2 in combination with approximately 22.5 wt. % lubricity additive. FIG. 6 shows that variations of 1 wt. % in the lubricity additive did not have a significant impact on wear performance. However, ball wear performance slightly improved by increasing the concentration of the lubricity additive.

TABLE 8
Ball and Plate Wear for Wear-Reduction Corrosion Inhibitors with
33.33 wt. % Base CI #2 and Polyester of Ethylene Glycol Dimerate.

| Blend | Ball Wear (mm³) | Plate Wear (mm³) |
|---|---|---|
| Sample 500 | 2,228,908 | 2,000,000 |
| Sample 508 | 631,329 | N.D. |
| Base CI #2 + polyester of ethylene glycol dimerate | 32,242 ± 204 | N.D. |
| (21.5 wt. %) + solvent (balance) | | |
| Base CI #2 + polyester of ethylene glycol dimerate | 24,834 ± 334 | N.D. |
| (22.5 wt. %) + solvent (balance) | | |
| Base CI #2 + polyester of ethylene glycol dimerate | 20,035 ± 3,208 | N.D. |
| (23.5 wt. %) + solvent (balance) | | |

### Example 4

To observe the performance of lubricity additives in another embodiment of the wear-reduction corrosion inhibitor, another base corrosion inhibitor (Base CI #3) was formulated according to Table 9. Sample 700 included 24.8 wt. % Base CI #3 with solvent as the balance.

TABLE 9
Base CI #3 Formulation.

| | Wt. % based on |
|---|---|
| Component | total Sample 700 |
| Imidazoline and Fatty acid | 24.8 |
| Dimer acid | |
| Tall oil | |
| Demulsifier | |
| Surfactant | |

Samples 702, 704, and 706 were wear-reduction corrosion inhibitors that each included 24.8 wt. % Base CI #3, 10 wt. % lubricity additive (polyester of ethylene glycol dimerate), and solvent as the balance. With 10 wt. % polyester of ethylene glycol dimerate in combination with 24.8 wt. % Base CI #3, the viscosity at −40° C. was lower than that of 14 wt. % polyester of ethylene glycol dimerate combined with 21.5 wt. % Base CI #1 (compare Table 10 with Table 4).

TABLE 10
Viscosities for Wear-Reduction Corrosion Inhibitors with 24.8
wt. % Base CI #3 and Polyester of Ethylene Glycol Dimerate.

| | Viscosity | | Viscosity |
|---|---|---|---|
| | at −40° C. | Density | at −40° C. |
| Blend | (cSt) | (g/cm³) | (cP) |
| Base CI #3 + solvent (balance) | 130 | 0.8717 | 113.3 |
| Base CI #3 + polyester of ethylene glycol dimerate (8 | 380 | 0.8840 | 335.9 |
| wt. %) + solvent (balance) | | | |
| Base CI #3 + polyester of ethylene glycol dimerate (9 | 440 | 0.8858 | 389.8 |
| wt. %) + solvent (balance) | | | |
| Base CI #3 + polyester of ethylene glycol dimerate | 490 | 0.8871 | 434.7 |
| (10 wt. %) + solvent (balance) | | | |
| Base CI #3 + polyester of ethylene glycol dimerate | 550 | 0.8885 | 488.7 |
| (11 wt. %) + solvent (balance) | | | |

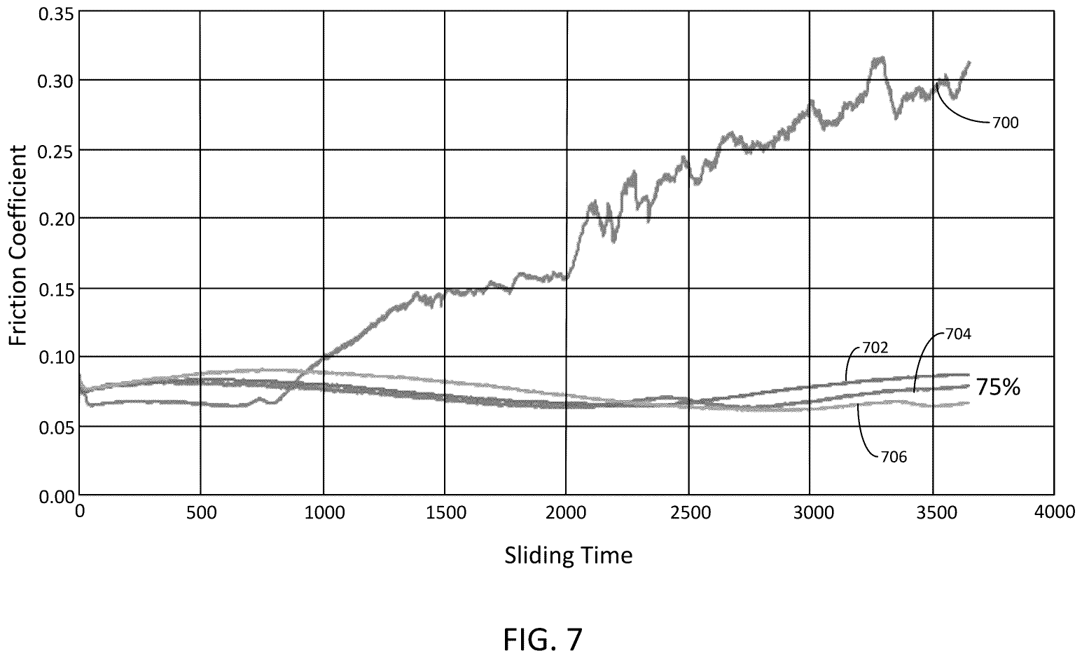

FIG. 7 depicts approximately 75% friction reduction for Samples 702, 704, and 706 compared to Sample 700. Table 11 depicts the ball wear and plate wear for wear-reduction corrosion inhibitors having 24.8 wt. % Base CI #3 and approximately 10 wt. % polyester of ethylene glycol dimerate for the lubricity additive. Deviations of 1 wt. % in lubricity additive concentration did not result in major changes for wear performance.

TABLE 11
Ball and Plate Wear for Wear-Reduction Corrosion Inhibitors with
24.8 wt. % Base CI #3 and Polyester of Ethylene Glycol Dimerate.

| Blend | Ball Wear (mm³) | Plate Wear (mm³) |
|---|---|---|
| Base CI #3 + solvent (balance) | 1,041,551 | 172,990 |
| Base CI #3 + polyester of ethylene glycol dimerate | 39,212 ± 5,788 | N.D. |
| (9 wt. %) + solvent (balance) | | |
| Base CI #3 + polyester of ethylene glycol dimerate | 31,940 ± 2,080 | N.D. |
| (10 wt. %) + solvent (balance) | | |
| Base CI #3 + polyester of ethylene glycol dimerate | 41,797 ± 9,701 | N.D. |
| (11 wt. %) + solvent (balance) | | |

### Example 5

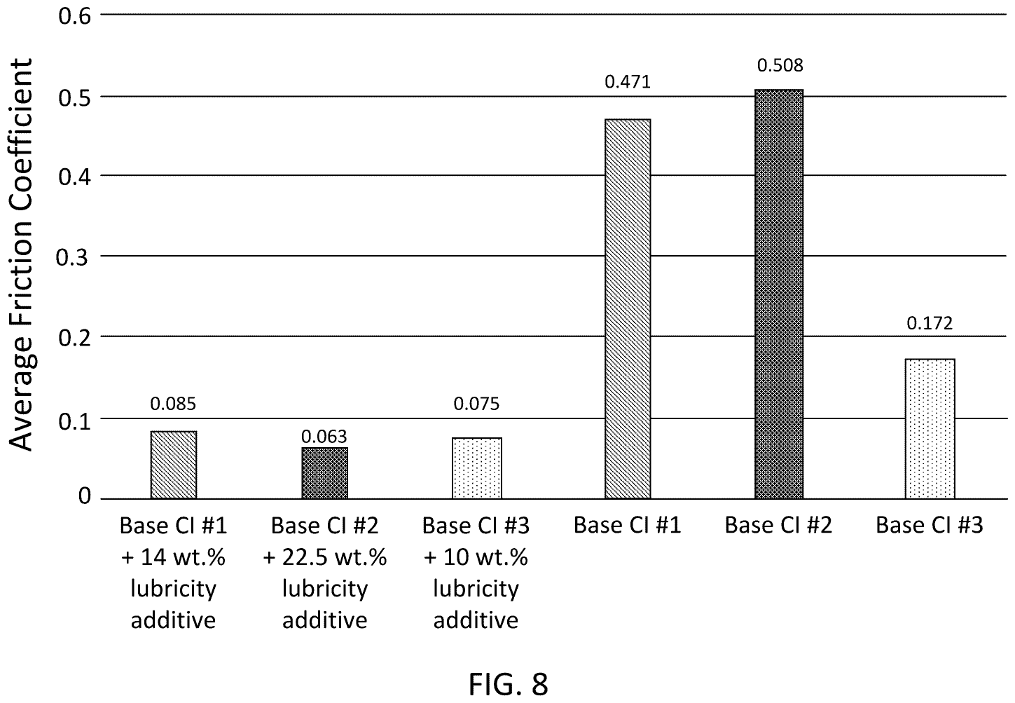

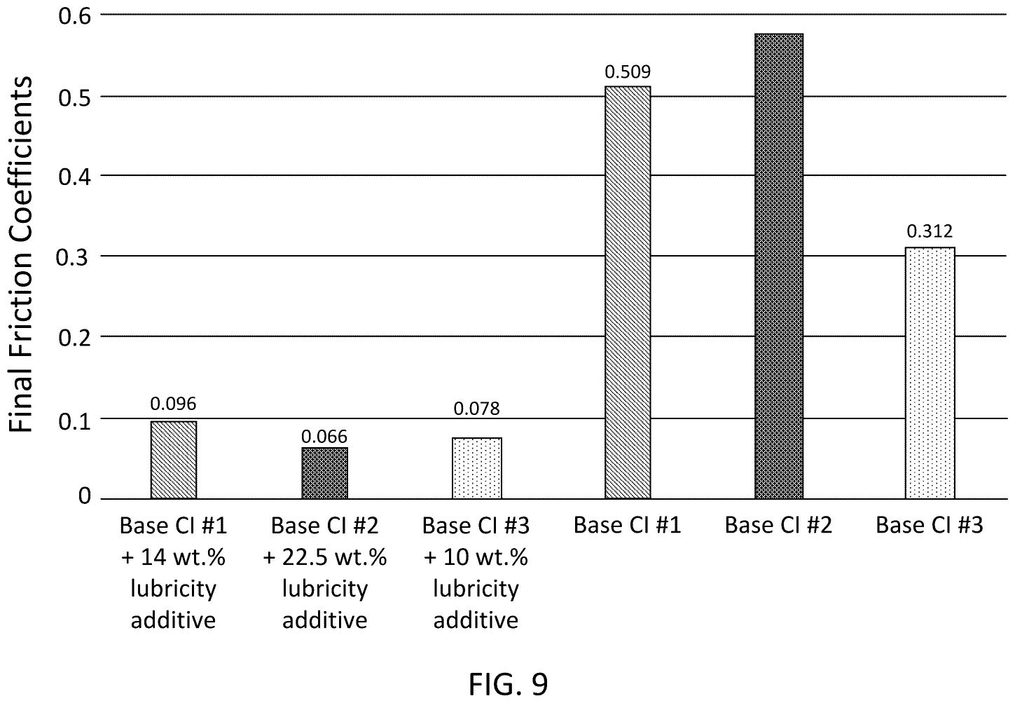

FIGS. 8 and 9 show the average and the final friction coefficients for wear-reduction corrosion inhibitors with Base CIs #1, #2, and #3 and polyester of ethylene glycol dimerate, as well as these base corrosion inhibitors without a lubricity additive. All of the wear-reduction corrosion inhibitors exhibited significant friction reduction in comparison to the respective base corrosion inhibitors. The final friction coefficients were only slightly higher than the average friction coefficients. Of the base corrosion inhibitors without lubricity additives, Base CI #3 exhibited the lowest average and final friction coefficients.

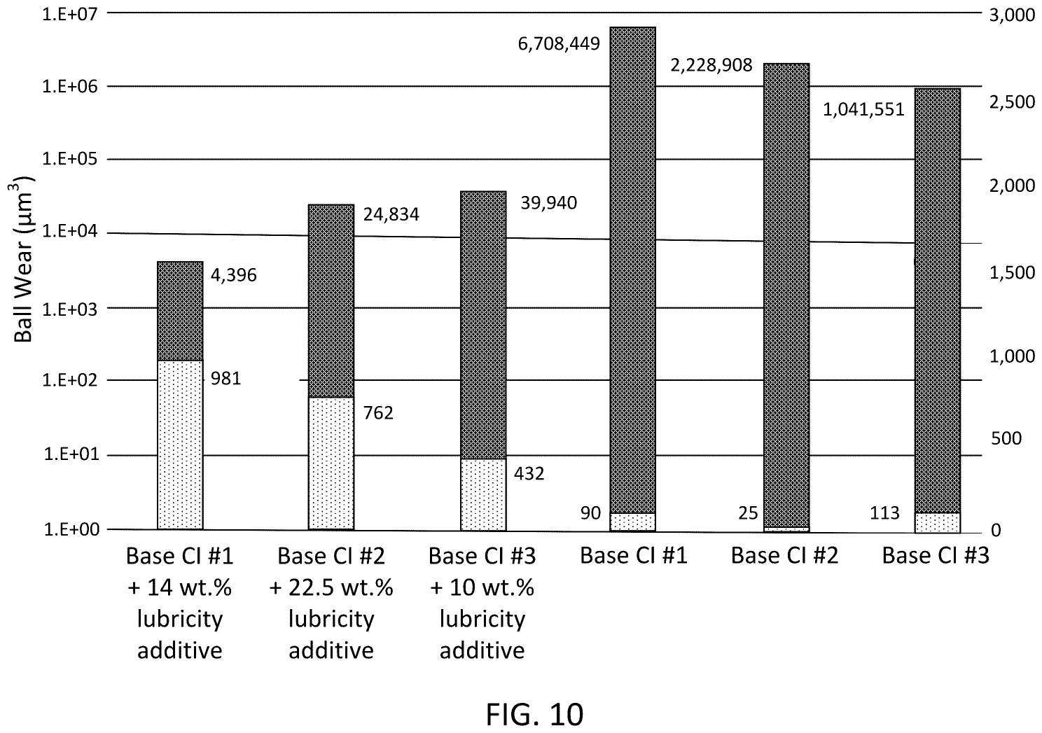

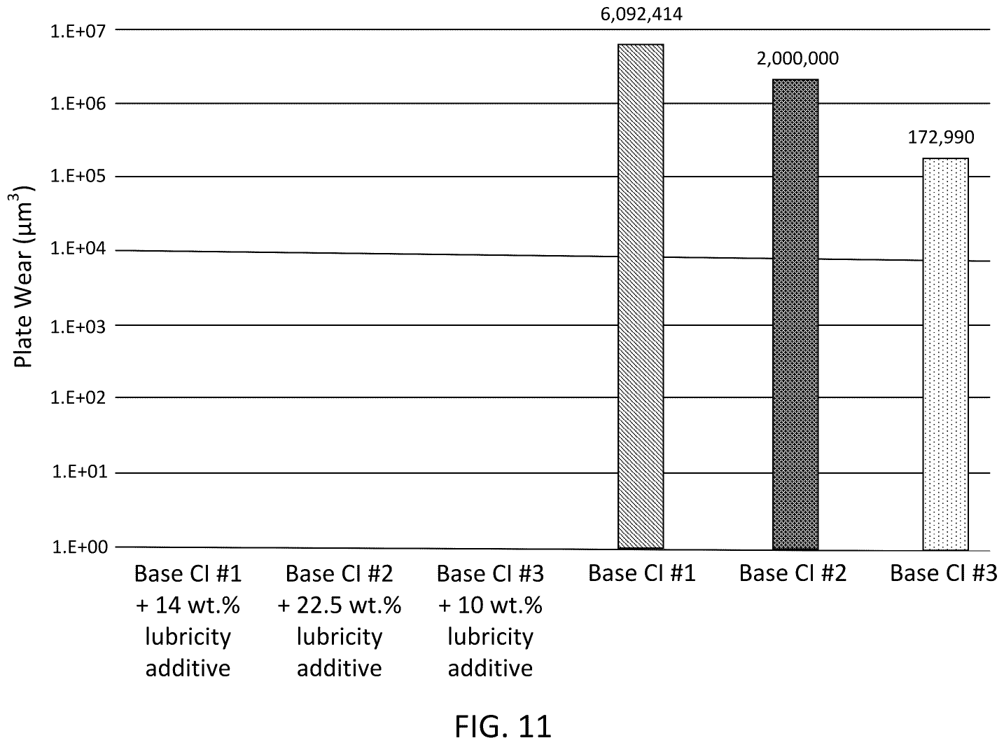

FIG. 10 shows ball wear results (dark shaded bar) for the samples of FIGS. 8 and 9. 21.5 wt. % Base CI #1 with 14 wt. % polyester of ethylene glycol dimerate exhibited the lowest ball wear volume, followed by 33.33 wt. % Base CI #2 with 22.5 wt. % polyester of ethylene glycol dimerate and 24.8 wt. % Base CI #3 with 10 wt. % polyester of ethylene glycol dimerate. FIG. 10 also shows the viscosities (light shaded bar) for these samples at −40° C. Viscosity did not appear to impact the ball wear volumes of the base corrosion inhibitors without lubricity additives, but it did impact the wear-reduction corrosion inhibitors that had the polyester of ethylene glycol dimerate. More particularly, higher viscosity correlated with lower ball wear volume. FIG. 11 shows plate wear volumes for the samples of FIGS. 8-10. No plate wear was detectable for the wear-reduction corrosion inhibitors having the polyester of ethylene glycol dimerate, possibly due to the short test duration (60 minutes).

### Example 6

Wheel bomb testing was used to evaluate the corrosion inhibition performance of the wear-reduction corrosion inhibitors. A high-pressure vessel (bomb) was attached to a rotating wheel to induce the movement of the testing fluids within the vessel. The test fluids included either synthetic brines or brine and hydrocarbon at the desired ratio. API 5L X65 steel coupons were pre-filmed by dipping each coupon into the wear-reduction corrosion inhibitor for one (1) minute and allowing the coupon to drip for thirty (30) seconds. Each coupon was dipped afterward in deoxygenated brine for one (1) minute and left to drip again for thirty (30) seconds. The coupons were then inserted into the bombs, followed by the addition of brine and hydrocarbon pre-sparged with CO₂. The bombs were capped, the fluids were subjected to additional sparging with CO₂ to remove oxygen, and the CO₂ pressure was set to 20 psi, after which the bombs were secured to the wheel. At this point, the oven containing the wheel was heated to 250° F. After 24 hours of rotation within the oven, the steel coupons were removed and weighed. The test conditions are shown in Table 12. The brine composition is shown in Table 13.

TABLE 12
Wheel Bomb Testing Conditions.

| Parameters | Values | |
|---|---|---|
| Temperature | 250° | F. |
| CO₂ Pressure | 20 | psia |
| Brine/Isopar M ratio | 50:50 | |
| Duration | 24 | hrs. |

| | |
|---|---|
| Material | X65 |

TABLE 13
Brine Composition.

| Parameters | Concentration (mg/L) |
|---|---|
| Chlorides | 172,102 |
| Sulfate | 50 |
| Bicarbonate | 0 |
| Acetate | 0 |
| Sodium | 88,400 |
| Potassium | 7,543 |
| Magnesium | 1,121 |
| Calcium | 18,206 |
| Strontium | 1,758 |
| Barium | 0 |
| TDS | 289,180 |

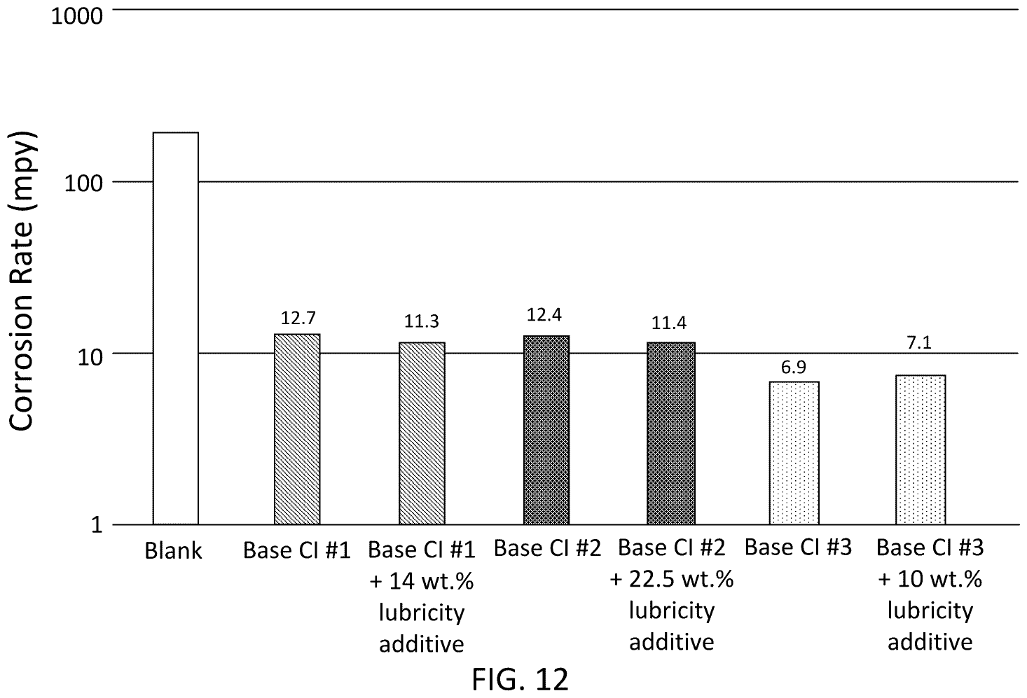

The mass loss was converted to a corrosion rate to determine the extent of corrosion inhibition protection for each coupon. FIG. 12 and Table 14 show the wheel bomb testing results, which indicated that the addition of the polyester of ethylene glycol dimerate was not detrimental for the corrosion inhibition performance of Base CIs #1, #2, and #3.

TABLE 14
Wheel Bomb Testing Results.

| | Corrosion | Inhibition |
|---|---|---|
| Blend | Rate (mpy) | Efficiency (%) |
| Blank | 189.2 ± 3.9 | — |
| Base CI #1 (21.5 wt. %) + solvent (balance) | 12.7 ± 0.8 | 93.3 |
| Base CI #1 (21.5 wt. %) + polyester of ethylene glycol | 11.3 ± 0.9 | 94.0 |
| dimerate (14 wt. %) + solvent (balance) | | |
| Base CI #2 (33.33 wt. %) + solvent (balance) | 12.4 ± 0.3 | 93.4 |
| Base CI #2 (33.33 wt. %) + polyester of ethylene glycol | 11.4 ± 0.6 | 94.0 |
| dimerate (22.5 wt. %) + solvent (balance) | | |
| Base CI #3 (24.8 wt. %) + solvent (balance) | 6.9 ± 0.7 | 96.4 |
| Base CI #3 (24.8 wt. %) + polyester of ethylene glycol | 7.1 ± 1.0 | 96.2 |
| dimerate (10 wt. %) + solvent (balance) | | |

Further experiments indicated that all of the tested wear-reduction corrosion inhibitors demonstrated thermal stability. No solids or phase separation was observed in the wear-reduction inhibitors after they were exposed to 250° F. for seven days using bombs pressurized to 1,000 psi with nitrogen.

For purposes of the disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a process comprising two or more defined steps, the defined steps can be carried out in any order or simultaneously (except where context excludes that possibility), and the process can also include one or more other steps which are carried out before any of the defined steps, between two of the defined steps, or after all the defined steps (except where context excludes that possibility).

Still further, additional aspects of the invention may be found in one or more appendices attached hereto and/or filed herewith, the disclosures of which are incorporated herein by reference as if fully set out at this point.

Thus, the invention is adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

1. (canceled)

2. (canceled)

3. (canceled)

4. (canceled)

5. (canceled)

6. (canceled)

7. (canceled)

8. (canceled)

9. (canceled)

10. A method of treating downhole equipment within a well with a wear-reduction corrosion inhibitor, the method comprising the steps of:
preparing a wear-reduction corrosion inhibitor, wherein the step of preparing the wear-reduction corrosion inhibitor comprises combining:
a base corrosion inhibitor comprising a fatty acid; and
a lubricity additive comprising an ester-based lubricant, wherein the ester-based lubricant comprises a complex ester selected from the group consisting of diisopropyl ether dimerate, ethylene glycol dimerate, and polyesters of ethylene glycol dimerate; and
pumping the wear-reduction corrosion inhibitor into an annulus of the well.

11. The method of claim 10, wherein the step of preparing the wear-reduction corrosion inhibitor further comprises combining:
between about 70 wt. % and about 90 wt. % base corrosion inhibitor; and
between about 10 wt. % and about 30 wt. % lubricity additive.

12. The method of claim 11, wherein the step pumping the wear-reduction corrosion inhibitor into the annulus comprises pumping between about 0.5 gallons and about 2 gallons of the wear-reduction corrosion inhibitor into the annulus per 2,000 ft. of production tubing in the well.

13. The method of claim 10, further comprising the step of combining the wear-reduction corrosion inhibitor with a carrier fluid in a concentration of between about 10 and about 100 ppm of wear-reduction corrosion inhibitor to carrier fluid.

14. The method of claim 10, further comprising the step of flushing the annulus with water or a water-based fluid after the step of pumping the wear-reduction corrosion inhibitor into the annulus of the well.

15. The method of claim 14, wherein the flushing step further comprises flushing the annulus with about 2 barrels of water within the annulus when the fluid level within the annulus is less than 1,000 ft deep.

16. The method of claim 14, wherein the flushing step further comprises flushing the annulus with about 10 barrels of water within the annulus when the fluid level within the annulus is greater than 1,000 ft deep.

17. The method of claim 14, wherein the steps of pumping the wear-reduction corrosion inhibitor into the annulus and flushing the well with water or the water-based fluid are performed daily, once a week, every two weeks, every three weeks, or monthly.

18. The method of claim 14, further comprising the step of stopping circulation within the well after the steps of pumping the wear-reduction corrosion inhibitor into the annulus and flushing the well with water or the water-based fluid.

19. A method of treating downhole equipment within a well with a wear-reduction corrosion inhibitor, the method comprising the steps of:
preparing a wear-reduction corrosion inhibitor, wherein the step of preparing the wear-reduction corrosion inhibitor comprises combining:
a base corrosion inhibitor comprising a fatty acid; and
a lubricity additive comprising an ester-based lubricant, wherein the ester-based lubricant comprises a complex ester selected from the group consisting of diisopropyl ether dimerate, ethylene glycol dimerate, and polyesters of ethylene glycol dimerate;
combining the wear-reduction corrosion inhibitor with a carrier fluid;
pumping the wear-reduction corrosion inhibitor and carrier fluid into the well; and
flushing the well with water or a water-based fluid after the step of pumping the wear-reduction corrosion inhibitor and carrier fluid into the well.

20. The method of claim 10, wherein the step of preparing the wear-reduction corrosion inhibitor further comprises obtaining the base corrosion inhibitor, wherein the fatty acid in the base corrosion inhibitor is selected from tall oil fatty acids and derivatives of the same, dimer fatty acids and derivatives of dimer fatty acids, and mixtures thereof.

21. The method of claim 10, wherein the step of preparing the wear-reduction corrosion inhibitor further comprises obtaining the base corrosion inhibitor, wherein the base corrosion inhibitor further comprises an imidazoline and a phosphate ester.

22. The method of claim 21, wherein the base corrosion inhibitor comprises between about 1 wt. % and about 20 wt. % fatty acid, between about 1 wt. % and about 20 wt. % imidazoline, and between about 2 wt. % and about 20 wt. % phosphate ester.

23. The method of claim 22, wherein the base corrosion inhibitor comprises between about 1 wt. % and about 10 wt. % fatty acid, between about 2 wt. % and about 10 wt. % surfactant, between about 5 wt. % and about 20 wt. % imidazoline, between about 2 wt. % and about 15 wt. % phosphate ester, and between about 1 wt. % and about 2 wt. % demulsifier.

24. The method of claim 22, wherein the base corrosion inhibitor comprises between about 2 wt. % and about 20 wt. % fatty acid, between about 1 wt. % and about 5 wt. % surfactant, between about 1 wt. % and about 10 wt. % imidazoline, between about 5 wt. % and about 20 wt. % phosphate ester, and between about 5 wt. % and about 20 wt. % quaternary amine.

25. (canceled)

26. (canceled)
